(19) United States
(12) Patent Application Publication
(10) Pub. No.: US 2006/0170382 A1
(43) Pub. Date: Aug. 3, 2006

(54) Linear motor force ripple identification and compensation with iterative learning control

(75) Inventors: Pai-Hsueh Yang, Palo Alto, CA (US); Hideyuki Hashimoto, Tokyo (JP); Bausan Yuan, San Jose, CA (US); Atsushi Yamaguchi, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nikon Corporation, Tokyo (JP)

(21) Appl. No.: 11/046,092

(22) Filed: Jan. 28, 2005

(51) Int. Cl. H02K 33/00; H02K 41/00

(52) U.S. Cl. 318/114; 310/10; 310/12

(57) ABSTRACT

Embodiments of the present invention are directed to compensating for force ripple of an apparatus driven by a force produced by a linear motor. In one embodiment, a method of compensating for force ripple comprises generating force commands for a trajectory starting at a plurality of starting positions of the apparatus driven by the linear motor to produce different trajectory motions based on the same trajectory at the plurality of starting positions, the force commands each including peaks of large acceleration/deceleration and valleys of low force levels; calculating an average of the force commands during large acceleration/deceleration generated based on trajectory motions for the plurality of starting positions; calculating a variation ratio of the force command for each trajectory motion to the calculated average of the force commands; and compensating for force ripple in the apparatus based on the calculated variation ratio to control the force applied by the linear motor to the apparatus.

### CROSS-REFERENCES TO RELATED APPLICATIONS

Not Applicable

### BACKGROUND OF THE INVENTION

The present invention relates generally to a control system and method for controlling the trajectory and alignment of one or more stages in a semiconductor wafer exposure system and, more particularly, to reducing following error in the iterative learning control (ILC) methodology by compensating for force ripple.

An exposure apparatus is one type of precision assembly that is commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, a measurement system, and a control system.

In one embodiment, the wafer stage assembly includes a wafer stage that retains the wafer, and a wafer mover assembly that precisely positions the wafer stage and the wafer. The reticle stage assembly includes a reticle stage that retains the reticle, and a reticle mover assembly that positions the reticle stage and the reticle. The control system independently directs current to the wafer mover assembly and the reticle mover assembly to generate one or more forces that cause the movement along a trajectory of the wafer stage and the reticle stage, respectively.

The size of the images and features within the images transferred onto the wafer from the reticle are extremely small. Accordingly, the precise positioning of the wafer and the reticle relative to the optical assembly is critical to the manufacture of high density, semiconductor wafers. In some embodiments, numerous identical integrated circuits are derived from each semiconductor wafer. Therefore, during this manufacturing process, the wafer stage and/or the reticle stage can be cyclically and repetitiously moved to emulate an intended trajectory. Each intended trajectory that is similar to a previous intended trajectory of one of the stages is also referred to herein as an “iteration” or a “cycle.”

Unfortunately, during the movement of the stages, a following error of the wafer stage and/or the reticle stage can occur. The following error is defined by the difference between the intended trajectory of the wafer stage and/or the reticle stage and an actual trajectory of the stage at a specified time. For example, the following error can occur due to a lack of complete rigidity in the components of the exposure apparatus, which can result in a slight time delay between current being directed to the mover assembly and subsequent movement of the stage.

Additionally, alignment errors can occur even if the stages are properly positioned relative to each other. For example, periodic vibration disturbances of various mechanical structures of the exposure apparatus may occur. More specifically, oscillation or resonance of the optical assembly and/or other supporting structures can inhibit relative alignment between the stages and the optical assembly. As a result of the following errors and/or the vibration disturbances, precision in the manufacture of the semiconductor wafers can be compromised, potentially leading to production of a lesser quality semiconductor wafer.

Attempts to decrease the following errors include the use of a feedback control loop. In these types of systems, during movement of one of the stages, the measurement system periodically provides information regarding the current position of the stage. This information is utilized by the control system to adjust the level of current to the mover assembly in an attempt to achieve the intended trajectory. Unfortunately, this method is not entirely satisfactory and the control system does not always precisely move each stage along its intended trajectory.

In light of the above, there is a need for a control system that can improve the accuracy in the positioning of the stage. Further, there is a need for a control system that can accurately adjust the positioning of the wafer stage and/or the reticle stage to produce higher quality semiconductor wafers.

### BRIEF SUMMARY OF THE INVENTION

Embodiments of the present invention are directed to compensating for force ripple of an apparatus driven by a force produced by a linear motor. More particularly, the force ripple compensation is used in conjunction with iterative learning control to render the control method simpler, more effective, and more robust. Accurate control of the motion of mechanical stages may be achieved to meet the demands of high acceleration, high speed, and high accuracy of lithography systems or the like.

In accordance with an aspect of the present invention, a method of compensating for force ripple of an apparatus driven by a force produced by a linear motor comprises generating force commands for a trajectory starting at a plurality of starting positions of the apparatus driven by the linear motor to produce different trajectory motions based on the same trajectory at the plurality of starting positions, the force commands each including peaks of large acceleration/deceleration and valleys of low force levels; calculating an average of the force commands during large acceleration/deceleration generated based on trajectory motions for the plurality of starting positions; calculating a variation ratio of the force command for each trajectory motion to the calculated average of the force commands; and compensating for force ripple in the apparatus based on the calculated variation ratio to control the force applied by the linear motor to the apparatus.

In some embodiments, the method further comprises performing an iterative learning control process on iterative learning control input data used to control the force applied by the linear motor to the apparatus. Compensating for force ripple comprises generating a force ripple lookup table based on the calculated variation ratio and applying the force ripple lookup table to a control signal for controlling the force applied by the linear motor to the apparatus.

In some embodiments, the iterative learning control input data comprises a following error which is a difference between an intended trajectory for the apparatus and an actual trajectory of the apparatus. Compensating for force ripple comprises generating a force ripple lookup table based on the calculated variation ratio; and applying the force ripple lookup table to the following error subsequent to the iterative learning control process to produce a control signal for controlling the force applied by the linear motor to the apparatus.

In specific embodiments, the method further comprises generating a feedback control signal based on the following error subsequent to the iterative learning control process; generating a feedforward control signal based on the intended trajectory; and combining the feedback control signal and the feedforward control signal to produce an adjusted following error. Compensating for force ripple comprises generating a force ripple lookup table based on the calculated variation ratio; and applying the force ripple lookup table to the adjusted following error to produce a control signal for controlling the force applied by the linear motor to the apparatus.

Another aspect of the invention is directed to a system of controlling movement of a stage including at least one linear motor to produce a force to move a substrate for processing. The system comprises a position compensation module configured to generate a force ripple compensation for adjusting the force applied by the linear motor to the stage; and a stage control module configured to use the generated force ripple compensation to control movement of the stage to compensate for force ripple of the linear motor.

In some embodiments, the position compensation module is configured to generate force commands for a trajectory starting at a plurality of starting positions of the stage driven by the linear motor to produce different trajectory motions based on the same trajectory at the plurality of starting positions, the force commands each including peaks of large acceleration/deceleration and valleys of low force levels; to calculate an average of the force commands during large acceleration/deceleration generated based on trajectory motions for the plurality of starting positions; to calculate a variation ratio of the force command for each trajectory motion to the calculated average of the force commands; and to determine the force ripple compensation based on the calculated variation ratio to control the force applied by the linear motor to the stage.

Another aspect of the present invention is directed to a system for controlling movement of a stage including at least one linear motor to produce a force to move a substrate for processing. The system has one or more memories. The one or more memories comprise code for generate a force ripple compensation for adjusting the force applied by the linear motor to the stage; and code for using the generated force ripple compensation to control movement of the stage to compensate for force ripple of the linear motor.

### BRIEF DESCRIPTION OF THE DRAWINGS

FIG. 1 is a schematic view of an exposure apparatus having features of the present invention.

FIG. 2A is a perspective view of a stage assembly having features of the present invention.

FIG. 2B is a perspective view of another stage assembly having features of the present invention.

FIG. 3A is a graph including curves illustrating an intended trajectory and an actual trajectory as a function of time during movement of a stage over a plurality of iterations.

FIG. 3B is a graph illustrating a following error of the stage in FIG. 3A as a function of time.

FIG. 4 is a graph illustrating an actual trajectory as a function of time during movement of the stage over a plurality of iterations.

FIG. 5 are block diagrams showing three conventional control system configurations employing iterative learning control (ILC) for controlling a stage assembly.

FIG. 6 is a simplified schematic view of a wafer stage.

FIG. 7 is a block diagram of a control system utilizing ILC for controlling a wafer stage.

FIG. 8 is a block diagram of an ILC method according to an embodiment of the invention.

FIG. 9 shows magnitude and phase characteristics of a zero-phase FIR Q filter in the ILC block diagram of FIG. 8.

FIG. 10 shows plots of iteration-wise error propagation rate with learning gain of 1.

FIG. 11 shows plots of iteration-wise error propagation rate with learning gain of 0.3.

FIG. 12 shows plots of iteration-wise error propagation rate with various learning gains.

FIG. 13 shows plots of error reduction after various iterations.

FIG. 14 shows plots of input to feedback controller with ILC and following errors with and without ILC.

FIG. 15 shows plots of correlation of WY following error and WY position.

FIG. 16 shows plots of control force command versus position for the same trajectory with variable starting positions.

FIG. 17 shows a close-up view of the plots of FIG. 16 illustrating force ripples in the high control force area.

FIG. 18 shows a close-up view of the plots of FIG. 16 illustrating viscosity ripples in the low control force area.

FIG. 19 shows the force ripple pitch and oscillation magnitude using four sets of results obtained from the high acceleration/deceleration of positive/negative scanning positions.

FIG. 20 shows a graphical representation of a force ripple compensation lookup table.

FIG. 21 is a block diagram of a control system utilizing ILC with force ripple compensation for controlling a linear motor stage.

FIG. 22 shows plots of trajectories for ILC for different starting positions with no position offset and with 5 mm and 15 mm position offsets.

FIG. 23 shows following errors for various starting positions without force ripple compensation.

FIG. 24 shows following errors for various starting positions with force ripple compensation.

FIG. 25 is a diagrammatic representation of a photolithography apparatus which includes a scanning stage with a dual force mode fine stage in accordance with another embodiment of the present invention.

FIG. 26 is a process flow diagram which illustrates the steps associated with fabricating a semiconductor device in accordance with an embodiment of the present invention.

FIG. 27 is a process flow diagram which illustrates the steps associated with processing a wafer, i.e., step 1304 of FIG. 26, in accordance with an embodiment of the present invention.

FIG. 28 shows the movement track of the center of the illumination slit during the exposure of multiple shot areas on wafer W.

FIG. 29 shows the track created by center P of illumination slit ST as it passes over respective shots on the wafer when shots S1, S2 and S3 are exposed in sequence.

FIG. 30(A) shows an example jerk profile of the stage.

FIG. 30(B) shows an example acceleration profile of the stage.

FIG. 30(C) shows an example velocity profile of the stage.

FIG. 30(D) shows an example position profile of the stage.

### DETAILED DESCRIPTION OF THE INVENTION

Lithography systems demand high acceleration, high speed and extreme accuracy on the motion of mechanical stages. Conventional following error driven feedback controls such as PID alone cannot meet the performance requirement due to the closed-loop bandwidth limitations from the mechanical resonance modes and electrical amplifiers. Although the system performance may be enhanced by feedforward control and feedback linearization, the models may not be accurate enough to meet the performance specification due to the system complexity. Due to the repetitive pattern of the step-scan-and-repeat of wafer stage motions, ILC may serve as the final resort to compensate all the repetitive residual following errors to ensure excellent settling time and accuracy.

Iterative learning control (ILC) has been intensely studied and applied to many control systems with repetitive motions. In contrast to the general compensations, based on the information of previous time steps, the ILC incrementally adjust its control command to reduce the following error based on the information from the previous iterations of repetitive motion. After several learning iterations as the following error reaches the specification, the final ILC array may be saved in the computer memory and later be retrieved and applied as a feedforward control for a similar trajectory without repeating the learning process.

Although ILC may perfectly reduce the following error caused by almost any repeatable uncertainty and disturbance, the trajectory dependent characteristics of ILC crucially limits its application. For instance, slight change in velocity or acceleration of a trajectory results in slightly different ILC learning results. Numerical synthesis such as interpolation of fixed number of learning results may extend the effectiveness to different operation conditions from the learning processes.

Another aspect of difficulties in the ILC application to real systems is due to the existence of state-variable dependent disturbances. For instance, the linear motor force constant variation, so-called force ripples, may make the learned ILC not so perfect as it is directly applied to a trajectory of slightly different starting position, despite of same acceleration and velocity settings. Similar numerical synthesis scheme mentioned above may generalize the effectiveness of ILC learning results to every trajectory starting position without repeating the learning. However, the combination of so many different operation conditions may make the implementation of ILC learning and application procedures rather complicated.

Besides control, the ILC may also be used as an identification tool. For instance, the ILC capability of producing perfect controls makes possible the convenient and truthful identification of state-variable dependent disturbances through the mapping from the interested state variables to the control command variation. This mapping, in the forms of equations or lookup tables, may be applied along with the ILC learning and application to attenuate the state-variable dependency. Even without ILC applied, this nonlinear control, known as feedback linearization, alone may already significantly improve the tracking performance.

Exposure Apparatus & Stage Movement Control

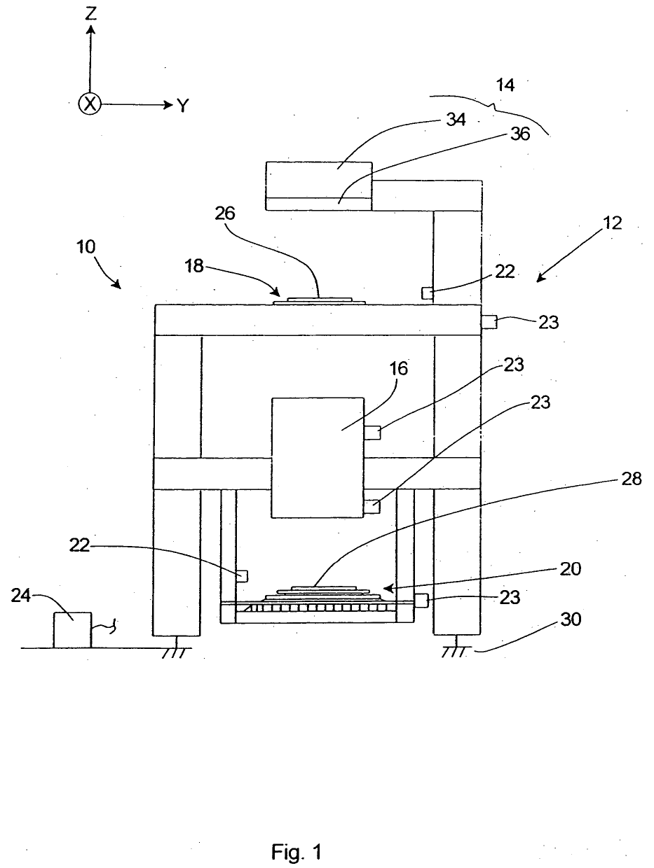

FIG. 1 is a schematic illustration of a precision assembly, namely, an exposure apparatus 10. The exposure apparatus 10 includes an apparatus frame 12, an illumination system 14 (irradiation apparatus), an assembly 16 such as an optical assembly, a reticle stage assembly 18, a wafer stage assembly 20, a measurement system 22, one or more sensor 23, and a control system 24 having features of the present invention. The control system 24 may be a computer having a processor and a memory storing codes and data to be processed and executed by the processor. The specific design of the components of the exposure apparatus 10 may be varied to suit the design requirements of the particular application.

As provided herein, the control system 24 utilizes a position compensation system or module that improves the accuracy in the control and relative positioning of at least one of the stage assemblies 18, 20. An orientation system used herein includes an X axis, a Y axis which is orthogonal to the X axis, and a Z axis which is orthogonal to the X and Y axes. The X, Y, and Z axes are also referred to as first, second, and third axes. The exposure apparatus 10 is particularly useful as a lithographic device that transfers a pattern of an integrated circuit from a reticle 26 onto a semiconductor wafer 28. The exposure apparatus 10 is mounted to a mounting base 30, such as the ground, a base, a floor, or some other supporting structure.

There are different types of lithographic devices. For example, the exposure apparatus 10 may be used as a scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the assembly 16 by the reticle stage assembly 18 and the wafer 28 is moved perpendicularly to the optical axis of the assembly 16 by the wafer stage assembly 20. Scanning of the reticle 26 and the wafer 28 occurs while the reticle 26 and the wafer 28 are moving synchronously.

The apparatus frame 12 is rigid and supports the components of the exposure apparatus 10. As seen in FIG. 1, the apparatus frame 12 supports the assembly 16 and the illumination system 14 above the mounting base 30. The illumination system 14 includes an illumination source 34 and an illumination optical assembly 36. The illumination source 34 emits a beam (irradiation) of light energy. The illumination optical assembly 36 guides the beam of light energy from the illumination source 34 to the assembly 16. The beam illuminates selectively different portions of the reticle 26 and exposes the wafer 28. The assembly 16 is typically an optical assembly that projects and/or focuses the light passing through the reticle 26 to the wafer 28. Depending upon the design of the exposure apparatus 10, the assembly 16 can magnify or reduce the image illuminated on the reticle 26. The assembly 16 need not be limited to a reduction system, but may be a 1× or a magnification system.

The reticle stage assembly 18 holds and positions the reticle 26 relative to the assembly 16 and the wafer 28. Somewhat similarly, the wafer stage assembly 20 holds and positions the wafer 28 with respect to the projected image of the illuminated portions of the reticle 26. Movement of the stages generates reaction forces that can affect performance of the photolithography system. Typically, numerous integrated circuits are derived from a single wafer 28. Therefore, the scanning process may involve a substantial number of repetitive, identical, or substantially similar movements of portions of the reticle stage assembly 18 and/or the wafer stage assembly 20. Each such repetitive movement is also referred to herein as an iteration, iterative movement, or iterative cycle.

The measurement system 22 monitors movement of the reticle 26 and the wafer 28 relative to the assembly 16 or some other reference. With this information, the control system 24 can control the reticle stage assembly 18 to precisely position the reticle 26 and the wafer stage assembly 20 to precisely position the wafer 28 relative to the assembly 16. For example, the measurement system 22 may utilize multiple laser interferometers, encoders, and/or other measuring devices. Additionally, one or more sensors 23 can monitor and/or receive information regarding one or more components of the exposure apparatus 10. Information from the sensors 23 can be provided to the control system 24 for processing. The control system 24 also receives information from the measurement system and other systems, and controls the stage mover assemblies 18, 20 to precisely and synchronously position the reticle 26 and the wafer 28 relative to the assembly 16 or some other reference. The control system 24 includes one or more processors and circuits for performing the functions described herein.

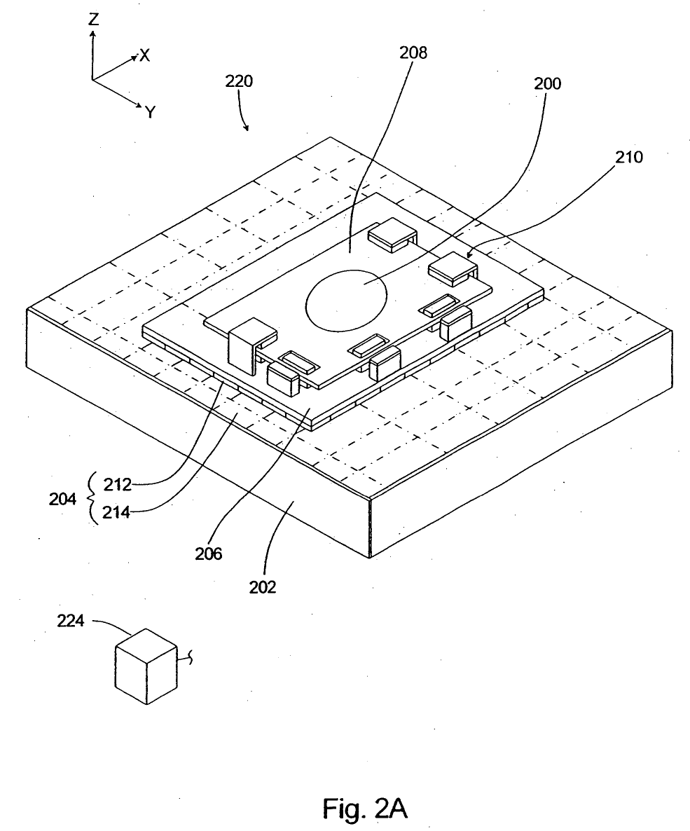

FIG. 2A shows a stage assembly 220 that is used to position a device 200, and a control system 224. The stage assembly 220 may be used as the reticle stage assembly 18 to position the reticle 26 of FIG. 1, or may also be used as the wafer stage assembly 20 to position the wafer 28 of FIG. 1. The stage assembly 220 includes a stage base 202, a coarse stage mover assembly 204, a coarse stage 206, a fine stage 208, and a fine stage mover assembly 210. The coarse stage mover assembly 204 moves the coarse stage 206 relative to the stage base 202 along the X axis, along the Y axis, and about the Z axis (collectively “the planar degrees of freedom”). The coarse stage mover assembly 204 includes a first mover component 212 that is secured to and moves with the coarse stage 206 and a second mover component 214 (illustrated in phantom) that is secured to the stage base 202. The first mover component 212 includes a magnet array, and the second mover component 214 includes a conductor array. The first mover component 212 can be maintained above the second mover component 214 with vacuum pre-load type air bearings or the like. The control system 224 directs current to one or more of the conductors in the conductor array. The electrical current through the conductors causes the conductors to interact with the magnetic field of the magnet array. This generates a force between the magnet array and the conductor array that can be used to control, move, and position the first mover component 212 and the coarse stage 206 relative to the second mover component 214 and the stage base 202. The control system 224 adjusts and controls the current level for each conductor to achieve the desired resultant forces, and to position the coarse stage 206 relative to the stage base 202.

The fine stage 208 includes a device holder that retains the device 200. The fine stage mover assembly 210 moves and adjusts the position of the fine stage 208 relative to the coarse stage 206. The fine stage mover assembly 210 typically moves the fine stage 208 in six degrees of freedom, but may provide only three degrees of freedom of movement in some cases.

FIG. 2B shows another stage assembly 220D that is used to position a device 200D, and a control system 224D having features of the present invention. The stage assembly 220D includes a stage base 202D, an X mover assembly 204D, a Y mover assembly 206D, a stage 208D, and a guide assembly 210D. The X mover assembly 204D includes a first X mover 250D and a second X mover 252D which move the guide assembly 210D and the stage 208D along the X axis. The Y mover assembly 206D includes a Y mover 254D that moves the stage 208D along the Y axis.

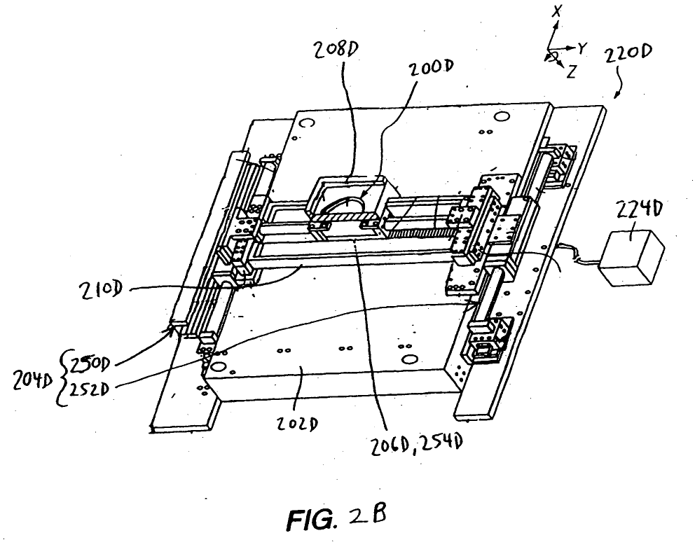

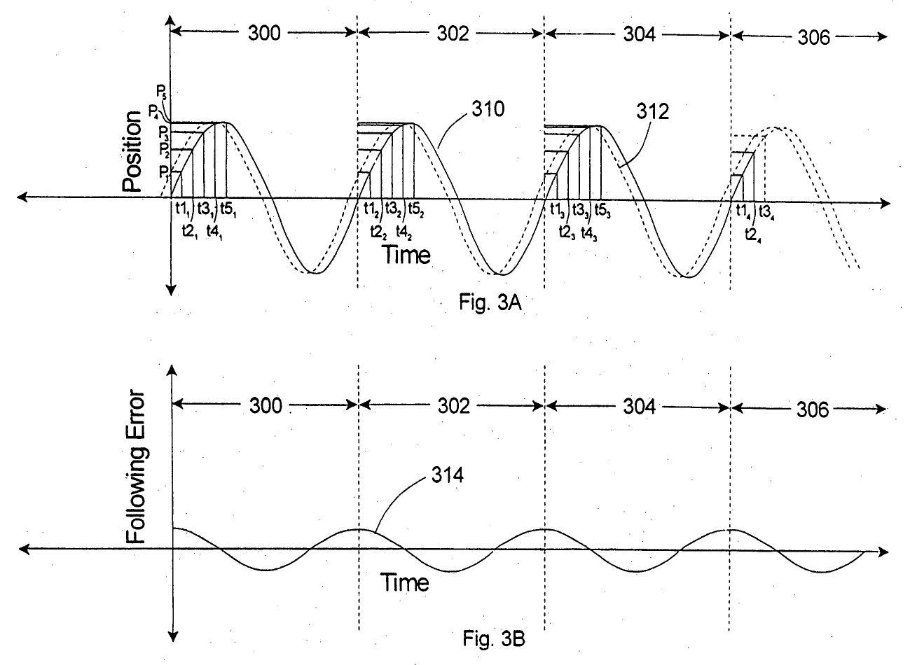

FIG. 3A is a graph illustrating an overview of an actual and an intended simplified back-and-forth type of iterative movement of a stage, such as the fine stage 208 shown in FIG. 2A or the stage 208D of FIG. 2B, along a single axis as a function of time over the course of a plurality of substantially similar iterations of the stage. The curve 310 (shown as a solid line) illustrates the actual trajectory of the stage, and the curve 312 (shown as a dashed line) illustrates the intended trajectory of the stage. The spacing between the curves 310, 312 has been exaggerated for illustrative purposes. Each iteration can include the intended trajectory of the stage and the actual trajectory of the stage that emulates the intended trajectory. Two or more intended trajectories can be considered iterations under various circumstances, as discussed in U.S. Provisional Application No. 60/424,506.

For illustrative purposes, FIG. 3A includes a first iteration 300, a second iteration 302, a third iteration 304, and a portion of a fourth iteration 306, which is also referred to herein as the “current iteration.” The actual trajectory 310 of an iteration may be substantially similar to the actual trajectory 310 of the previous iteration, although the identical trajectories 310 for each iteration 300-306 may not necessarily be identical. For example, during the first iteration 300 at times t1₁, t2₁, t3₁, t4₁, and t5₁, the measured position of the stage is located at positions P₁, P₂, P₃, P₄, and P₅ (hereinafter the “actual position”) respectively. Somewhat similarly, the second iteration 302 includes times t1₂ through t5₂, the third iteration 304 includes times t1₃ through t5₃, and the fourth iteration 306 includes t1₄ through t3₄. Each of the items t1₂ through t5₂ of the second iteration 302 and times t1₃ through t5₃ of the third iteration 304 has an actual position that is similar, though not necessarily identical, to a corresponding actual position P₁ through P₅, respectively. Each of the times t1₄ through t3₄ of the fourth iteration 306 has an actual position point that is similar, though not necessarily identical, to a corresponding actual position P₁ through P₃, respectively. It is recognized that the second and third iterations 302, 304, although similar in movement to previous first and second iterations 300, 302, respectively, can vary somewhat as a result of the additional information collected and utilized by the control system 24 and subsequent adjustments that the control system 24 makes in directing current to the one or more mover assemblies to cause forces that more accurately move the stage.

During learning, desired trajectories of various speeds and position lengths are applied and the respective learning results are saved individually. These learning results then can be interpolated for the applications of any speed and motion length later. It is noted that the above merely describes an example, and the “similarity” between the actual trajectory of an iteration and the actual trajectory of the previous iteration may be more general. After the learning is done, for instance, the velocity and shot-size may be changed.

The control system 24 provided herein can include one or more control modes. In one embodiment, the control system 24 includes a first control mode and a second control mode. As an overview, the first control mode includes the processing of input data such as positioning data received by the control system 24 during a single iteration to control future movement of the stage also during the first iteration. The second control mode includes the processing of input data received by the control system during at least one iteration (e.g., the first iteration 300 and the second iteration 302) to control future movement of the stage during the second iteration 302 and/or third iteration 304, as one example. In an iterative learning control (ILC) algorithm, the input data is referred to as learning algorithm input data. In general, the learning algorithm input data may include following error data or force command data. Force command refers to the force to be applied to the mechanical system to move a stage. The following error data can be derived from positioning data. The positioning data may include various types of information to be received and/or processed by the control system, such as time dependent positioning data or position dependent positioning data.

The first control mode can be described with reference to the first iteration 300 in FIG. 3A. In a simplified example, to determine the amount of current that the control system 24 needs to direct to the mover assemblies to position the stage in accordance with the intended trajectory 310 of the stage at time t4₁, time-dependent positioning data is provided to the control system 24 from one or more of the previous times t1₁ through t3₁. This positioning data is analyzed by the control system 24 along with the intended trajectory 310 to determine the force that is required to move the stage at time t4₁. With this positioning data, the control system 24 applies an appropriate control law to determine the amount of current to direct to the mover assemblies to obtain the required force distribution for moving the stage to the extent necessary for proper positioning of the stage. The number of data points t1₁ through t3₁ used in this analysis can vary. The first control mode can be used for movement of the stage with one or more degrees of freedom.

The second control mode can selectively be used by the control system 24 depending upon the requirements of the stage assembly. The second control mode includes the features of the first control mode described above, as well as the processing of learning algorithm input data received by the control system 24 during one or more previous iterations to control movement of the stage during the fourth iteration 302. In contrast with the first control mode, the learning algorithm input data from a previous iteration, but at a later point in time during the pervious iteration, can be used in controlling movement of the stage during the current iteration. For example, to determine the level of current to direct to the mover assembly at time t3₄, learning algorithm input data from times t4₁ and t5₁ from the first iteration 300, times t4₂ and t5₂ from the second iteration 302, and/or times t4₃ and t5₃ from the third iteration 304 can be used. This learning algorithm input data can be used in conjunction with or in the alternative to learning algorithm input data from times t1₁ through t3₁ of the first iteration 300, times t1₂ through t3₂ of the second iteration 302, and/or times t1₃ through t3₃ of the third iteration 304, or any portions thereof. With this design, a greater amount of learning algorithm input data factors into controlling the stage With the control system 24. Moreover, the second control mode can also utilize learning algorithm input data from the current iteration (e.g., the fourth iteration 306) to control the actual trajectory 310 during the current iteration 306. Thus, the second control mode of the control system 24 can take into account both intra-iteration and inter-iteration trends in the learning algorithm input data. Consequently, with each successive iteration, the positioning error is decreased.

FIG. 3B shows an example of the following error 314 of the stage over the first, second, third, and fourth iterations 300-306 based on the intended trajectory 312 and the actual trajectory 310 illustrated in FIG. 3A.

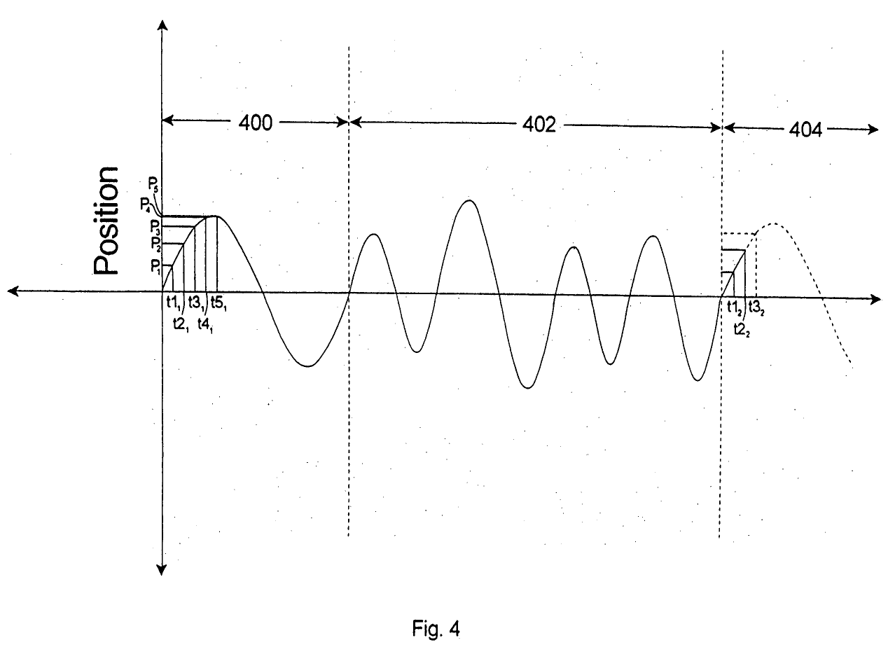

FIG. 4 is a graph that illustrates two simplified back-and-forth iterative movements of the stage as shown in FIG. 2A, for example, which include a first iteration 400 and a second iteration 404, separated in time by a period of other non-iterative movements 402 of the stage. In this embodiment, the second control mode of the control system provided herein does not necessarily require the iterations to be consecutive. For example, the control system can store learning algorithm input data from the first iteration 400 to be used for positioning the stage during the second iteration 404. The control system can identify when an intended movement or trajectory of the stage is similar to a previous movement or trajectory of the stage. Once this occurs, the control system can draw from the previously stored learning algorithm input data to adjust the amount of the current to direct to the mover assembly for more accurately positioning the stage in accordance with the intended trajectory of the stage.

Iterative Learning Control Methodology

FIG. 5 illustrates three conventional ILC configurations with various input and output. The subscript k in the figures and equations represents the iteration number. P is the plant and C the feedback controller. The signals uₖ, eₖ, yₖ, dₖ, and nₖ are the ILC output, following error, plant output, disturbance, and measurement noise respectively in iteration k. Although theoretically ILC alone can stabilize the system, the existence of a feedback controller makes the stability and performance of the overall system more robust in the real time implementation. The ILC control law usually includes a forward filter L and a low pass filter Q.

In the first configuration (Configuration I), ILC has input from the following error in previous iterations and output to current control command.
uₖ₊₁=uₖ+QLeₖ for Configuration I. (1)
The error propagation from iteration k to iteration k+1 is represented as follows.

$${e}_{k + 1} = ( 1 - \frac{P}{1 + PC} QL ) {e}_{k} + \frac{P}{1 + PC} ( {d}_{k} - {d}_{k + 1} ) + \frac{1}{1 + PC} ( {n}_{k} - {n}_{k + 1} ) \qquad ( 2 )$$

The above equation also leads to the convergence condition for the ILC with minor repeatability issues of disturbance and measurement noise.

$$\vert 1 - \frac{P}{1 + PC} QL \vert < 1 \qquad ( 3 )$$

In the second and third configurations (IIa, IIb), ILC has input from feedback control command in previous iterations and output to current control command in configuration IIa, while ILC has input from following error in previous iterations and output to current following error in configuration IIb.
uₖ₊₁=uₖ+QLuₖ^{fb} for Configuration IIa. (4)
uₖ₊₁=uₖ+QLeₖ for Configuration IIb. (5)
Basically Configurations IIa and IIb are equivalent in terms of the iteration-wise error propagation and convergence condition.

$$\begin{matrix}{e}_{k + 1} = ( 1 - \frac{PC}{1 + PC} QL ) {e}_{k} + \frac{P}{1 + PC} ( {d}_{k} - {d}_{k + 1} ) + \frac{1}{1 + PC} ( {n}_{k} - {n}_{k + 1} ) & ( 6 ) \\ \vert 1 - \frac{P}{1 + PC} QL \vert < 1 & ( 7 )\end{matrix}$$

Ideally no low pass filter is needed and the ILC forward filter L may be designed as follows such that the error would be completely removed after a learning iteration.

$$\begin{matrix}L = {( \frac{P}{1 + PC} )}^{- 1} for Method I & ( 8 ) \\ L = {( \frac{PC}{1 + PC} )}^{- 1} for Method s IIa and IIb & ( 9 )\end{matrix}$$

In reality, a low-pass Q filter needs to attenuate the un-modeled dynamics to maintain the stability for all frequencies. In addition, more than one learning iterations may be required to average out the effect of non-repeatability of disturbance and measurement noise. Since the ILC uses the old information from the previous iteration, a zero phase design of the Q filter makes the phase not be sacrificed as a regular low pass filter.

FIG. 6 shows a simplified view of a multi-dimensional system including a stage 600 driven to move in the X-direction by an X linear motor 602 and to move in the Y-direction by a front Y linear motor 604 and a back Y linear motor 606. In the practical control implementation on a multi-dimensional system, in additional to feedback control and ILC, more functional blocks are needed. As illustrated in the control system 700 of FIG. 7, an intended trajectory 702 is used as feedforward control (704). The intended trajectory 702 of the stage is determined based on the desired path of the device. The intended trajectory 702 can be along the X axis, along the Y axis, and/or about the Z axis. Additionally, the intended trajectory 702 may also include components about the X axis, about the Y axis, and/or along the Z axis, or any combination thereof.

One or more points in time along the intended trajectory 702 are compared with points in time from the actual trajectory 706 to determine whether the stage is properly positioned, and to determine whether the stage will be properly positioned in the immediate future. The actual trajectory 706 is determined by the measurement system 22 (FIG. 1) which generates a sensor signal. The measurement system 22 measures the current position of the stage, and thus the object, relative to the assembly 16 (FIG. 1). The sensor signal is then sent to the control system 700. Each sensor signal provides information relating to the actual position of the stage in one or more degrees of freedom at a specific point in time.

The following error 708 for the stage is determined by computing the difference between the intended trajectory 702 and the actual trajectory 706 at a specific point in time. The following error 708 undergoes a coordinate transformation 710, iterative learning control 712, and feedback control 714 to determine the extent to which the current to the one or more mover assemblies is adjusted, if at all. The resulting signal is combined with the feedforward control signal, and the current is distributed to the one or more mover assemblies as appropriate under force distribution 716. The mechanical system such as a wafer stage 718, which includes the mover assemblies, then moves the stage based on the control signal, causing the stage to more accurately emulate the intended trajectory 702 of the stage.

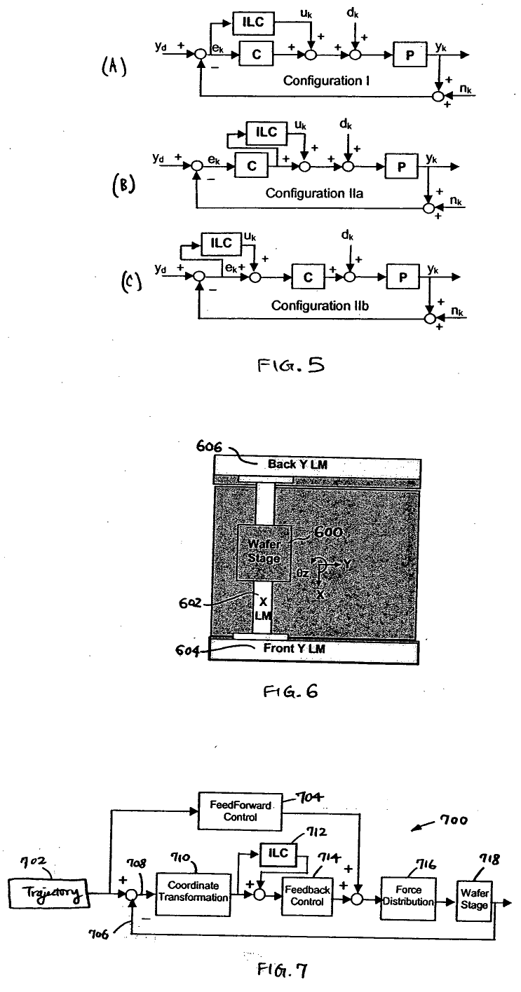

FIG. 8 shows one embodiment of the ILC 800, which includes two major filters: (1) the forward IIR filter 804 for the inverse dynamics of closed-loop system and (2) the zero-phase low pass FIR Q filter 802 (see FIG. 9). In addition, several other necessary operations in the ILC implementation are described as follows. The “ILC learning gain” 806 is to reduce the convergence rate and making the ILC converge more smoothly, averaging out the uncertainties through learning iterations. The “ILC End Smoothing” 808 algorithm is to gradually reduce the ILC output so as to avoid the discontinuity when the ILC sequence and the motion trajectory are ending. The “time ahead” 810 is to compensate the time-delay of the systems between input and output. The time delay may come from the mechanical dynamics, sensors, computation, amplifiers, etc. The ILC learning is powered by the “iteration integral” 812, modifying the ILC data buffer incrementally through iterations. The ILC learning results are stored in the “ILC data buffer” 814 or memory, and can be used purely as a feedforward control later.

The effective learning happens within the frequency range, where the iteration-wise error propagation rate is less than one.

$${μ}_{iepr} = \vert 1 - \overbrace{\underbrace{{k}_{ILC}}_{{learning}_{gain}} \underbrace{{G}_{FIR}}_{{zero }_{{phase}_{Q filter}}} \underbrace{{Z}^{timeAhead} {G}_{IIR}}_{{Inverse dynamics}_{{of closed \text{-} loop}_{system}}}}^{ILC controller} * \underbrace{{G}_{CL}}_{{closed}_{loop TF}} \vert < 1 \qquad ( 10 )$$

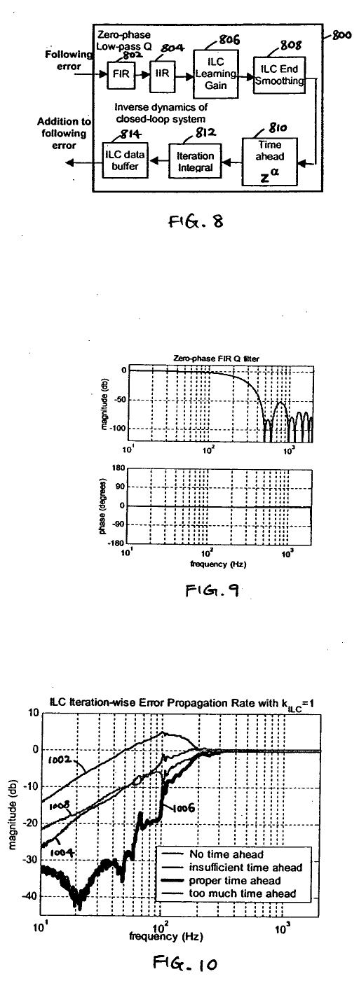

Proper time ahead has to be incorporated to the ILC controller to compensate the time delay of the closed loop system, otherwise either the learning is not efficient or the stability is endangered as illustrated in FIGS. 10 and 11. FIG. 10 shows iteration-wise error propagation rate with learning gain of 1 for no time ahead (1002), insufficient time ahead (1004), proper time ahead (1006), and too much time ahead (1008). FIG. 11 shows iteration-wise error propagation rate with learning gain of 0.3 for no time ahead (1102), insufficient time ahead (1104), proper time ahead (1106), and too much time ahead (1108).

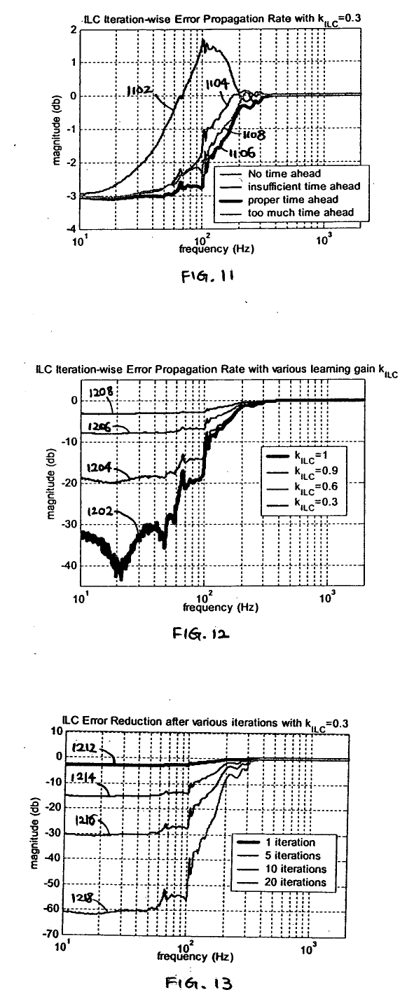

Since non-repeatable disturbance and measurement noise usually exist in the systems, smaller learning gain k_{ILC} may be used to average out those harmful effects. Reducing the learning rate also reduces the learning efficiency, as illustrated in FIG. 12, which shows iteration-wise error propagation rate with learning gain of 1 (1202), 0.9 (1204), 0.6 (1206), and 0.3 (1208). Thus, it needs to take more learning iterations to reach the target error reduction. With proper time-ahead in the ILC, the following error can be exponentially reduced as the learning iteration increases, as seen in FIG. 13, which shows error reduction after 1 iteration (1212), 5 iterations (1214), 10 iterations (1216), and 20 iterations (1218).

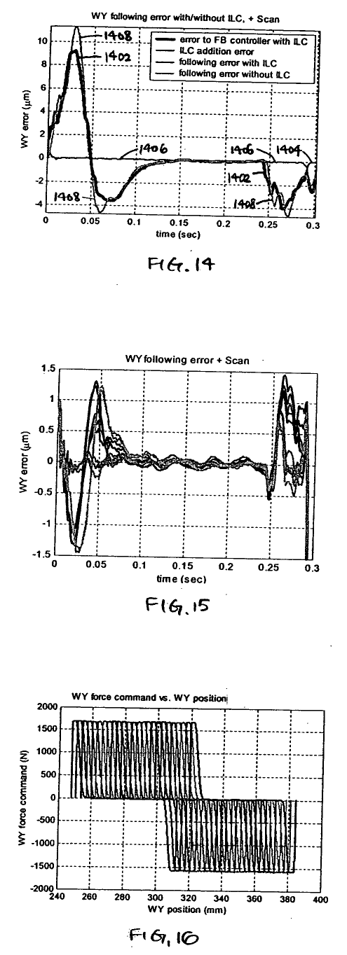

FIGS. 14 and 15 show experimental results of ILC. With the feedforward control of ILC learned at the same trajectory, the following error has been highly reduced, as illustrated in FIG. 14, which shows error to feedback controller with ILC (1402), ILC addition error (1404), following error with ILC (1406), and following error without ILC (1408). Basically the stage needs roughly the same amount of the same control force for the same trajectory motion. Without ILC the residual control force besides feedforward comes from feedback control with the penalty of large following error. ILC further supplements the feedforward control and relaxes the load of following error driven feedback control, rendering a much less following error.

However, as the same ILC feedforward is applied to different trajectory starting positions, it may not work as perfectly as at the learning location. In FIG. 15, similar following errors are achieved at the locations of the same WY but various WX positions. Hence, the ILC performance highly depends on the WY position. For this high performance wafer stage driven by linear motors, the linear motor force variation, proportional to control command, is the major position dependent disturbance during stage acceleration. Poor following error during acceleration period naturally leads to longer settling time for following error.

Force Ripple Identification and Compensation

Linear motors have been broadly used in the precision stages with well-known disturbances such as cogging force and force ripple. Force ripple effects in the scanning direction of a linear motor are periodic and similar for each phase. The dynamics for a mechanical stage driven by linear motor may be described as follows.

$$m \ddot{y} + c {\underbrace{( 1 + {R}_{vr} ( y ) )}}_{{viscosity}_{ripple}} \dot{y} + {\underbrace{k ( y ) y}}_{{cable force}_{or gravity}} + {\underbrace{{F}_{cf} ( y )}}_{{cogging}_{force}} = {\underbrace{( 1 + {R}_{fr} ( y ) )}}_{{force}_{ripple}} u \qquad ( 11 )$$

If only major components of the state-variable dependent disturbance force is counted, the equation may be simplified as follows.

$$m \ddot{y} + c {\underbrace{( 1 + {a}_{1} sin ( \frac{2 π y}{{L}_{1}} + {ϕ}_{1} )}}_{viscosity ripple} \dot{y} + {\underbrace{ky}}_{{cable force}_{or gravity}} + {\underbrace{{a}_{2} sin ( \frac{2 π y}{{L}_{2}} + {ϕ}_{2} )}}_{cogging force} = {\underbrace{( 1 + {a}_{3} sin ( \frac{2 π y}{{L}_{3}} + {ϕ}_{3} )}}_{force ripple} u \qquad ( 12 )$$

If the disturbance can be identified, then through a well-known nonlinear control design method, feedback linearization (13), ideally the tracking control problem for the nonlinear system (11) can be transformed to a following error regulation problem for a linear simple mass system (14).

$$\begin{matrix}u = \frac{1}{{\underbrace{1 + {R}_{fr} ( y )}}_{{force}_{ripple}}} \{ {\underbrace{m {\ddot{y}}_{d}}}_{feedforward} + c {\underbrace{( 1 + {R}_{vr} ( y ) )}}_{{viscosity}_{ripple}} \dot{y} + {\underbrace{k ( y ) y}}_{{cable}_{or gravity}} + {\underbrace{{F}_{cf} ( y )}}_{{cogging}_{force}} + {\underbrace{{u}_{fb}}}_{{linear}_{feedback}} \} & ( 13 ) \\ m ( {\ddot{y}}_{d} - \ddot{y} ) + {u}_{fb} = 0 & ( 14 )\end{matrix}$$

Detailed online or off-machine identification of those linear motor related disturbances might take a lot of effort. The ILC capability of producing perfect controls makes possible the convenient and truthful identification of state-variable dependent disturbances through the mapping from the interested state variables to the control command variation.

The following describes a methodology for the identification and compensation of linear motor force ripple according to one embodiment of the invention.

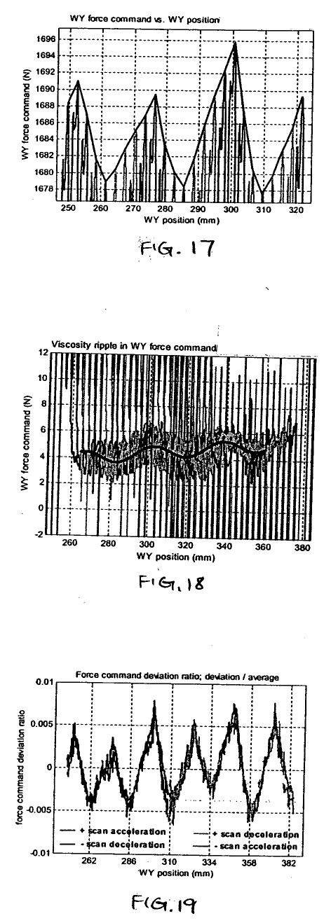

The first step is to obtain perfect control force commands for the same trajectory starting at various positions with the application of ILC such as the data shown in FIG. 16. As discussed above, force command refers to the force to be applied to the mechanical system to move a stage or the like. During high acceleration/deceleration, the clear control force variation in FIG. 17 is mainly due to the linear motor force ripples. A visible viscosity ripple may be observed along with a mild slope due to cable force or gravity effect in the low control force portions in FIG. 18. As verified by separate experiments with various scanning speeds, the oscillation magnitude of the viscosity ripples is proportional to the scanning velocity.

When obtaining control force commands in this first step, values of control force commands in the period during which the stage or the like is driven near maximum thrust (high acceleration/deceleration) and the velocity becomes almost zero might be obtained. Because the viscosity resistance generated by the linear motor is lost when the velocity becomes zero, the control force variation created then reflects linear motor force ripples more accurately. Therefore, more accurate compensation can be achieved by compensating linear force ripples in the manner to be described later using control force commands containing the control force variation.

FIGS. 28, 29 and 30 are diagrams for illustrating an example timing for obtaining control force commands while a stage assembly for mounting a wafer is driven. FIG. 28 shows the route of exposure during the sequential transfer of the reticle 26 pattern to multiple shot areas on wafer 28 by exposure apparatus 10 in FIG. 1. Here, the route in FIG. 28 indicates the track through which center P of an exposure light (illumination slit ST) emitted onto wafer 28 passes. The part of the track shown by the solid line indicates the route of center P (will be denoted also as “point P,” hereinafter) of illumination slit ST during exposures of respective shots; the part shown by the dotted line indicates the movement track of point P between adjoining shots within the same line in the non-scanning direction; and the part shown by the dot-dash line indicates the movement track of point P between different lines. Furthermore, although the fact is that point P is fixed and wafer 28 (stage assembly 20) moves, FIG. 28 is illustrated as if point P (center of illumination slit ST) moves on wafer 28 to simplify understanding of the explanation.

First, the inter shot stage movement operation to be carried out when adjoining shots on the same line, that is, first shot S1 and second shot S2 as shown in FIG. 29, are exposed in sequence will be explained, and then the timing for obtaining control force commands will be explained.

Here, in FIG. 30(A), jerk curve Jy(t) pertaining to the scanning direction (Y-axis direction) of stage assembly 20 is indicated by the solid line, and jerk curve Jx(t) pertaining to the non-scanning direction (X-axis direction) is indicated by the dotted line. In addition, in FIG. 30(B), acceleration curve Ay(t) pertaining to the scanning direction of stage assembly 20 corresponding to FIG. 30(A) is indicated by the solid line, and acceleration curve Ax(t) pertaining to the non-scanning direction is indicated by the dotted line. In FIG. 30(C), velocity curve Vy(t) pertaining to the scanning direction of stage assembly 20 corresponding to FIG. 30(A) and FIG. 30(B) is indicated by the solid line, and velocity curve Vx(t) pertaining to the non-scanning direction is indicated by the dotted line. In addition, in FIG. 30(D), disposition curve Py(t) pertaining to the scanning direction of stage assembly 20 corresponding to FIG. 30(A) through FIG. 30(C) is indicated by the solid line, and disposition curve Px(t) pertaining to the non scanning direction is indicated by the dotted line. In FIGS. 30(A) through 30(D), the horizontal axis indicates time (t). Furthermore, explanation of stage assembly 18 will be omitted.

First, the scanning direction (scanning direction: Y axis direction) will be considered. At point t2 (=t1+T4) after time T4 has passed from point t1 (at this time, point P is at the position of point A in FIG. 29) at which exposure of shot S1 has been completed, stage assembly 20 begins to decelerate (acceleration in the −Y direction when a velocity is present in the +Y direction in FIG. 29). Once the deceleration begins, the deceleration increases gradually (absolute value of acceleration in the −Y direction increases) to reach a prescribed fixed value (Aa), and the fixed value is maintained during a subsequent prescribed period of time ΔT (refer to FIG. 30(B)). Here, the deceleration time is the period between deceleration start point t2 and time Ty5. At this time, as shown in FIG. 30(C), stage assembly 20 moves in the +Y direction at fixed velocity Vscan for a duration of time T4 after exposure end point t1 with respect to reference point A (O,Ay) in FIG. 29. Subsequently, it further moves only for the duration of time Ty5 at a velocity in accordance with acceleration curve Vy(t) in FIG. 30(C) with respect to time reference point t2 which is reached when time T4 has passed. Point t3, that is, the point when the time Ty5 has passed, becomes bifurcation point B (Bx,By) at which prescanning of shot S2 as another partitioned area begins (refer to FIG. 29).

Subsequently, stage assembly 20 is accelerated for the duration of time Ty1 in the −Y direction at a velocity in accordance with acceleration curve Vy(t) in reference to acceleration start point t3. At the point t3, the velocity of stage assembly 20 in the Y direction becomes 0.

During the moving operation, acceleration curve Ay(t) shows the trapezoidal shape shown in FIG. 30(B) until sync setting period (T2) for the exposure of the next shot is reached after the exposure of a given shot has been completed. Thus, the ratio of the absolute value of the average acceleration (or the average deceleration) relative to the absolute value of the maximum acceleration (or the maximum deceleration) is improved. That is, the maximum acceleration (or the maximum deceleration) can be restrained, so that the generation of heat due to the down sizing of an actuator, such as a linear motor, for driving stage assembly 20 or its drive amplifier and due to the reduction in power consumption can be restrained at the time of the acceleration (or deceleration).

Acceleration is attained in the aforementioned manner: When point t4 shown in FIG. 30(B) is reached, stage assembly 20 reaches target scanning velocity −Vscan (here, the negative sign indicates a velocity in the −Y direction), and the exposure begins after time T2 as a period for controlling synchronization between reticle 26 and wafer 28 has passed. Exposure time T3 is expressed as T3=(shot length Ly+illumination slit width w)/Vscan.

Next, the moving operation (inter-shot stepping operation) in the non-scanning direction (non-scanning direction: X direction) will be considered. As shown in FIG. 30(C), acceleration of stage assembly 20 in the −X direction begins in accordance with acceleration curve Vx(t) as soon as point t1 at which the exposure of shot S1 has been completed is reached. Then, maximum velocity −Vx max (here, the negative sign indicates a velocity in the −X direction) is reached at the point at which time Tx5 has passed since the beginning of the acceleration. At this time, the X-coordinate of stage assembly 20 is −Bx, and point P is located at point B (Bx,By) in FIG. 29. Next, deceleration (acceleration in the +X direction when the velocity is in the −X direction) begins from the point in accordance with acceleration curve Vx(t). Then, when time Tx1 has passed after the deceleration start point (acceleration end point), the deceleration is ended, and the velocity becomes 0 (in other words, movement pertaining to the non scanning direction is stopped). At this time, the X-coordinate of stage assembly 20 is −Lx (Lx represents the stepping length), and point P has reached point C (Lx,Cy) in FIG. 29.

That is, concerning the scanning direction, as shown in FIG. 30(C), the acceleration for the exposure of the next shot ends at point t4 at which time (T4+Ty5+Ty1) has passed after point t1 at which the exposure of the previous shot ended. In contrast, for the non scanning direction, as shown in FIG. 30(C), the acceleration ends at the point at which time (Tx5+Tx1) has passed from the point at which the exposure of the previous shot ended. Accordingly, assuming that Ty1=Tx1 and Ty5=Tx5 hold, it is clear that the stepping operation ends before the beginning of the synchronization control at setting time T2 in the scanning direction by T4. At this time, the track of stage assembly 20 follows a parabola as shown in FIG. 29.

The fact that the stepping operation in the non scanning direction ends before the beginning of the synchronization control at the setting time in the aforementioned scanning direction means that movement of stage assembly 20 in the X and Y directions is controlled in such a manner that the moving operation (stepping operation) in the non-scanning direction is carried out simultaneously with the overscan and prescan operations of stage assembly 20 in the scanning direction such that X-coordinate Bx at point B (Bx,By) in FIG. 29 as the point at which the velocity in the scanning direction is zero, that is, the point at which the acceleration for the exposure of the next shot begins upon the ending of the deceleration, becomes closer to S2 than to the boundary between shots S1 and S2.

In this case, as is clear from FIG. 30(B) and FIG. 30(C) also, acceleration Ax(t) and velocity Vx(t) change constantly with respect to the non-scanning direction, and stage assembly 20 keeps moving constantly with respect to the non-scanning direction. In other words, stage assembly 20 carries out the stepping operation simultaneously with the run up operation in the scanning direction without ever stopping. Therefore, the inter shot moving operation (including the scanning direction and the non scanning direction) of stage assembly 20 can almost be achieved in the minimum time, so that the throughput can be improved.

Furthermore, the moving operation of the stage assembly is disclosed in Japanese Kokai Patent Application No. 2004-72076, for example, and the aforementioned application will be used as a part of the present specifications.

Next, timing for obtaining control force commands over stage assembly 20 during the moving operation of aforementioned stage assembly 20 will be explained.

As described above, when obtaining control force commands over stage assembly 20, values of control force commands in the period during which the stage assembly 20 is driven at maximum thrust (high acceleration/deceleration) and the velocity becomes zero might be obtained. That is, values of control force commands over stage assembly 20 at time t3 (when at point B (Bx,By) in FIG. 29) at which the velocity in the Y direction becomes 0 in FIG. 30(C) might be obtained. At this time, as shown in FIG. 30(B), the acceleration of stage assembly 20 in the Y direction is at its maximum at −Aa (period indicated by ΔT), and stage assembly 20 is driven at the maximum thrust in the Y direction. Therefore, the viscosity resistance generated by the actuator (the linear motor) driving stage assembly 20 becomes almost 0, and the control force variation generated then reflects force ripples at the time of generation of the maximum thrust accurately.

As shown in FIG. 28, transfer of the reticle 26 pattern onto the multiple shot areas on wafer 28 involves multiple rounds of movement between adjoining shots located within the same line (X direction) shown in FIG. 29. For example, in FIG. 29, a point at which the moving velocity of stage assembly 20 in the Y direction becomes 0, such as point B, can also be found on the moving route between second shot S2 and third shot S3. Therefore, when obtaining information on the control force commands, the information on the control force commands should be obtained at the position at which the moving velocity of stage assembly 20 becomes almost 0 in the Y direction (and the position at which it is driven at maximum thrust) while stage assembly 20 is moving between respective adjoining shots. For example, information on control force commands may be obtained at points (for example, points 2 through 5) before and after the point at which the velocity becomes 0. In addition, pieces of information obtained at the several points may be averaged.

An accurate compensation can be attained when linear motor force ripples are compensated using control force commands obtained in the manner. Furthermore, in FIG. 28, information on the control force commands does not have to be obtained at all points (locations) at which the moving velocity of stage assembly 20 in the Y direction becomes 0. For example, information on the control force commands may be obtained once for every few points. In addition, information on control force commands obtained at another position at which the moving velocity is not 0 (a section where the moving velocity is close to 0, yet is not constant) may also be combined for compensation of linear motor force ripples.

In addition, in FIG. 29, the moving direction of the wafer (or the stage assembly on which the wafer is mounted) changes from the +Y-axis direction to the −Y-axis direction when moving from first shot S1 to second shot S2, and the moving direction of the wafer changes from the −Y-axis direction to the +Y-axis direction when moving from second shot S2 to third shot S3. Thus, information on the control force commands which scrutinizes the direction (+ or −) the wafer movement is switched may also be utilized. In such a case, the following methods may be selected arbitrarily, for example. (i) Pieces of information on the control force commands are obtained when the movement of the wafer changes from the +Y-axis direction to the −Y-axis direction and when it changes from the −Y-axis direction to the +Y-axis direction, and the averaged information is used for compensation of linear motor force ripples. (ii) Information on the control force commands is obtained either when the wafer movement direction changes from the +Y-axis direction to the −Y-axis direction or from the −Y-axis direction to the +Y-axis direction as a representing value, and the representing value is used for compensation of linear motor force ripples. (iii) Pieces of information on the control force commands are obtained when the movement of the wafer changes from the +Y-axis direction to the −Y-axis direction and when it changes from the −Y-axis direction to the +Y-axis direction, and they are stored separately. Then, during the actual compensation of the linear motor force ripples, information obtained on control force commands when the +Y-axis direction switched to the −Y-axis direction is used for compensation of linear motor force ripples when the movement direction of the wafer (the stage assembly) changes from the +Y-axis direction to the −Y-axis direction, and the information on control force commands obtained when the −Y direction switched to the +Y direction is used for compensation of linear motor force ripples when it changes from the −Y direction to the +Y direction.

Furthermore, linear motor force ripples may be compensated in the X-axis direction in the same manner as that in the Y-axis direction. As shown in FIGS. 28 through 30, during the movement of the wafer (the stage assembly), the acceleration is also 0 when the velocity of the wafer in the X-axis direction is 0, creating a condition in which no thrust for driving the wafer in the X-axis direction is generated by the linear motor. Thus, the linear motor for driving in the X-axis direction is driven (by carrying out the control indicated by the solid line in FIG. 30) in the same manner as the linear motor in FIG. 30 for moving in the Y-axis direction in order to obtain the values of control force commands in the period during which it is driven near maximum thrust (high acceleration/deceleration), and the velocity approaches zero. The linear motor force ripples of the linear motor for the X-axis (the non-scanning direction) can be compensated accurately like linear motor force ripples of the linear motor for the Y-axis (the scanning direction) using information on control force commands obtained in the manner.

The second step is to calculate the average of the force command during large acceleration/deceleration (i.e., high force magnitudes) for trajectory motions at different positions. Since the position dependent ripples may be averaged out, the average value reconstructs the ideal force command in the ideal condition without the influence of force ripples. If there exists significant position dependent disturbance forces other than force ripple, they may need to be deducted from the force command before the averaging.

$${u}_{avg} ( t ) = \frac{1}{N} {\sum }_{k = 0}^{N - 1} {\overline{u}}_{k} ( t ) \\ where \\ {\overline{u}}_{k} ( t ) = {u}_{k} ( t ) * significant disturbances other than force ripples {u}_{k} ( t ) = control force command at time t of trajectory k \qquad ( 15 )$$

The third step is to calculate the variation ratio from the control force of each trajectory motion to the average values.

$${u}_{k , ripple\_ratio} ( t ) = \frac{{u}_{k} ( t )}{{u}_{avg} ( t )} - 1 \qquad ( 16 )$$

The plot of control force variation ratio vs. position in FIG. 19 clearly shows the force ripple pitch and oscillation magnitude. Four sets of results obtained from the high acceleration/deceleration of positive/negative scanning positions seem to match each other quite well. After a simple averaging treatment based on position index, this mapping may be applied to effectively compensate for the linear motor force ripples.

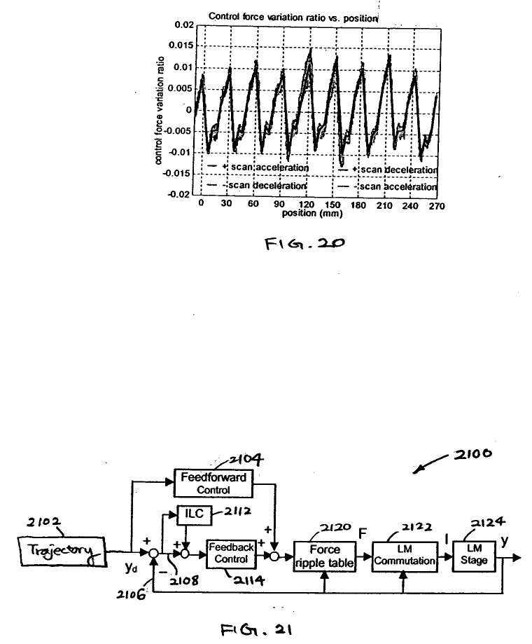

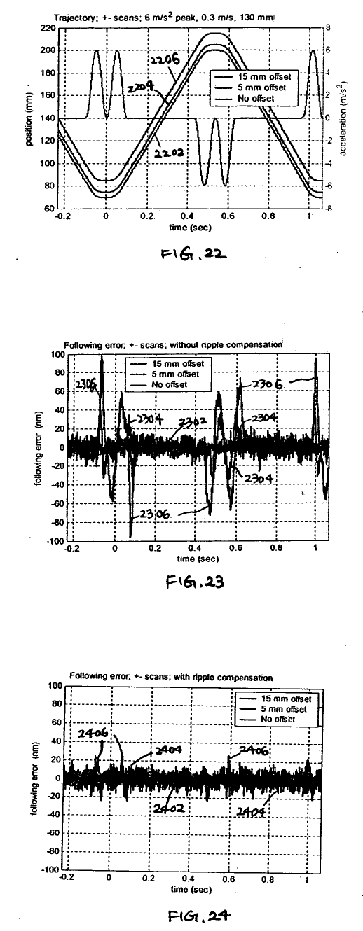

To quickly verify the force ripple compensation capability, a similar lookup table (illustrated in graphical form in FIG. 20) is constructed and incorporated in the control system 2100 of FIG. 21 on a linear motor driven, single DOF (degree of freedom), air-bearing stage, following the guidelines described above. As shown in the control system 2100 of FIG. 21, an intended trajectory 2102 is used as feedforward control (2104). The intended trajectory 2102 of the stage is determined based on the desired path of the device. One or more points in time along the intended trajectory 2102 are compared with points in time from the actual trajectory 2106 to determine whether the stage is properly positioned, and to determine whether the stage will be properly positioned in the immediate future. The actual trajectory 2106 is determined by the measurement system 22 (FIG. 1) which generates a sensor signal. The measurement system 22 measures the current position of the stage, and thus the object, relative to the assembly 16 (FIG. 1). The sensor signal is then sent to the control system 2100. Each sensor signal provides information relating to the actual position of the stage in one or more degrees of freedom at a specific point in time.

The following error 2108 for the stage is determined by computing the difference between the intended trajectory 2102 and the actual trajectory 2106 at a specific point in time. The following error 2108 undergoes iterative learning control 2112 and feedback control 2114 to determine the extent to which the current to the one or more mover assemblies is adjusted, if at all. The resulting feedback control signal is combined with the feedforward control signal. The combined signal undergoes force ripple compensation 2120 and then linear motor (LM) commutation 2122, which also utilize the actual trajectory 2106 signal, to produce a current to be applied to the one or more mover assemblies as appropriate. The mechanical system such as a linear motor (LM) stage 2124, which includes the mover assemblies, then moves the stage based on the control signal, causing the stage to more accurately emulate the intended trajectory 2102 of the stage.

FIG. 22 shows trajectories for ILC, with no offset (2202), 5 mm offset (2204), and 15 mm offset (2206). Originally without the ripple compensation lookup table, as illustrated in FIG. 23, the ILC feedforward learned for a trajectory cannot work as perfect for the trajectories with the 5 and 15 mm position offsets shown in FIG. 22. In FIG. 23, the following errors for 5 mm offset (2304) and 15 mm offset (2306) are substantial as compared with that for no offset (2302). The learned ILC feedforward with linear motor ripple well compensated beforehand can also attenuate the following error for trajectories starting at different positions, as seen in FIG. 24. The following errors for 5 mm offset (2404) and 15 mm offset (2406) are significantly reduced and are not much larger than that with no offset (2402).

ILC feedforward has effectively attenuated the following error for a high performance wafer stage when applied to the same position trajectory as during learning. However its effectiveness to trajectories with position offsets is limited by the linear motor force ripple, the dominating position dependent disturbance force during acceleration/deceleration. A force ripple compensation lookup table conveniently constructed with the help of ILC has successfully relaxed this position dependency limitation for the ILC application.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

Photolithography and Wafer Processing

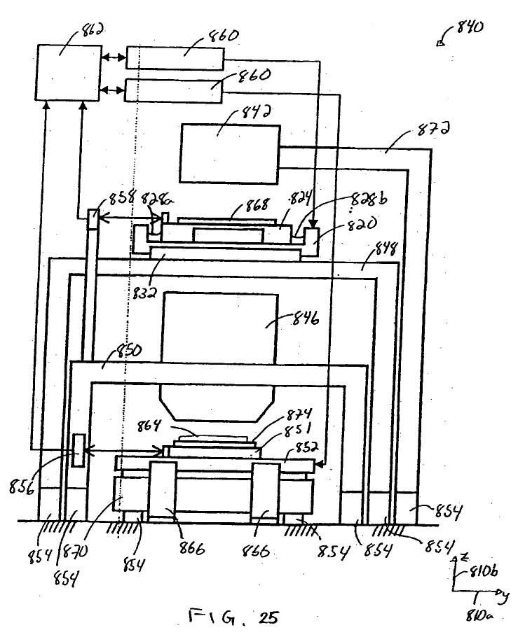

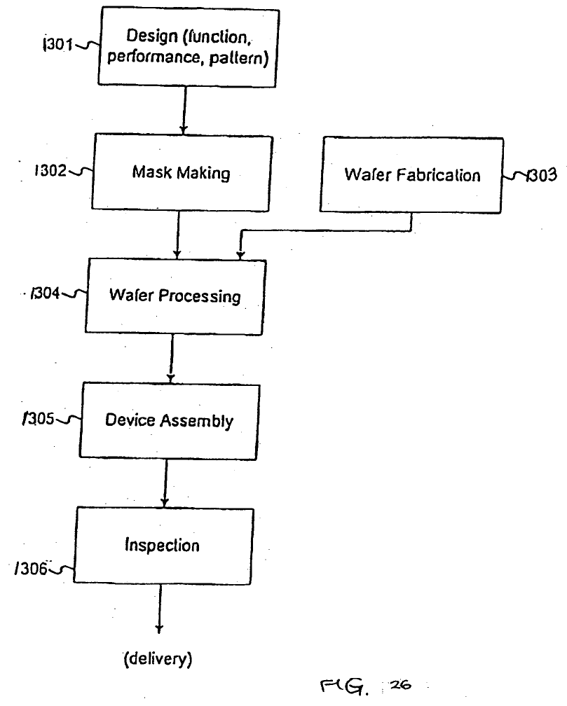

An overall reticle scanning stage device with dual force mode capabilities may be used as a part of a photolithography apparatus. With reference to FIG. 25, a photolithography apparatus which includes an overall reticle scanning stage device with dual force mode capabilities will be described in accordance with an embodiment of the present invention. A photolithography apparatus (exposure apparatus) 840 includes a wafer positioning stage 852 that may be driven by a planar motor (not shown), as well as a wafer table 851 that is magnetically coupled to wafer positioning stage 852. It should be appreciated that, in one embodiment, wafer positioning stage 852 may include a wafer coarse stage and a wafer fine stage which include dual force mode capabilities similar to those described above for a reticle scanning stage.

The planar motor which drives wafer positioning stage 852 generally uses an electromagnetic force generated by magnets and corresponding armature coils arranged in two dimensions. A wafer 864 is held in place on a wafer holder 874 which is coupled to wafer table 851. Wafer positioning stage 852 is arranged to move in multiple degrees of freedom, e.g., between three to six degrees of freedom, under the control of a control unit 860 and a system controller 862. The movement of wafer positioning stage 852 allows wafer 864 to be positioned at a desired position and orientation relative to a projection optical system 846.

Wafer table 851 may be levitated in a z-direction 810b by any number of voice coil motors (not shown), e.g., three voice coil motors. In the described embodiment, at least three magnetic bearings (not shown) couple and move wafer table 851 along a y-axis 810a. The motor array of wafer positioning stage 852 is typically supported by a base 870. Base 870 is supported to a ground via isolators 854. Reaction forces generated by motion of wafer positioning stage 852 may be mechanically released to a ground surface through a frame 866. One suitable frame 866 is described in JP Hei 8-166475 and U.S. Pat. No. 5,528,118, which are each herein incorporated by reference in their entireties.

An illumination system 842 is supported by a frame 872. Frame 872 is supported to a ground via isolators 854. Illumination system 842 includes an illumination source, and is arranged to project a radiant energy, e.g., light, through a mask pattern on a reticle 868 that is supported by and scanned using a reticle stage which includes a coarse stage 820 and a fine stage 824. The radiant energy is focused through projection optical system 846, which is supported on a projection optics frame 850 and may be released to the ground through isolators 854. Coarse stage 820 and fine stage 824 are connected by cords 828 which enable fine stage 824 to accelerate with coarse stage 820 in y-direction 810a, as described above. Specifically, when a linear motor 832 causes coarse stage 820 to accelerate in y-direction 810a, one of cords 828 is pulled into tension by the acceleration of coarse stage 820 to cause fine stage 824 to accelerate. For instance, when acceleration is in a positive y-direction 810a, then cord 828b may be pulled into tension. Alternatively, when acceleration is in a negative y-direction 810a, then cord 828a may be pulled into tension. A stator of linear motor 832 is connected to a reticle stage frame 848, therefore reaction forces generated by motion of coarse stage 820 and fine stage 824 may be mechanically released to a ground surface through isolators 854. Suitable isolators 854 include those described in JP Hei 8-330224 and U.S. Pat. No. 5,874,820, which are each incorporated herein by reference in their entireties.

A first interferometer 856 is supported on projection optics frame 850, and functions to detect the position of wafer table 851. Interferometer 856 outputs information on the position of wafer table 851 to system controller 862. A second interferometer 858 is supported on projection optics frame 850, and detects the position of coarse stage 820 and, in one embodiment, fine stage 824. Interferometer 858 also outputs position information to system controller 862.

It should be appreciated that there are a number of different types of photolithographic apparatuses or devices. For example, photolithography apparatus 840, or an exposure apparatus, may be used as a scanning type photolithography system which exposes the pattern from reticle 868 onto wafer 864 with reticle 868 and wafer 864 moving substantially synchronously. In a scanning type lithographic device, reticle 868 is moved perpendicularly with respect to an optical axis of a lens assembly (projection optical system 846) or illumination system 842 by coarse stage 820 and fine stage 824. Wafer 864 is moved perpendicularly to the optical axis of projection optical system 846 by a positioning stage 852. Scanning of reticle 868 and wafer 864 generally occurs while reticle 868 and wafer 864 are moving substantially synchronously.

Alternatively, photolithography apparatus or exposure apparatus 840 may be a step-and-repeat type photolithography system that exposes reticle 868 while reticle 868 and wafer 864 are stationary, e.g., when neither a fine stage 820 nor a coarse stage 824 is moving. In one step and repeat process, wafer 864 is in a substantially constant position relative to reticle 868 and projection optical system 846 during the exposure of an individual field. Subsequently, between consecutive exposure steps, wafer 864 is consecutively moved by wafer positioning stage 852 perpendicularly to the optical axis of projection optical system 846 and reticle 868 for exposure. Following this process, the images on reticle 868 may be sequentially exposed onto the fields of wafer 864 so that the next field of semiconductor wafer 864 is brought into position relative to illumination system 842, reticle 868, and projection optical system 846.

It should be understood that the use of photolithography apparatus or exposure apparatus 840, as described above, is not limited to being used in a photolithography system for semiconductor manufacturing. For example, photolithography apparatus 840 may be used as a part of a liquid crystal display (LCD) photolithography system that exposes an LCD device pattern onto a rectangular glass plate or a photolithography system for manufacturing a thin film magnetic head. Further, the present invention may also be applied to a proximity photolithography system that exposes a mask pattern by closely locating a mask and a substrate without the use of a lens assembly. Additionally, the present invention provided herein may be used in other devices including, but not limited to, other semiconductor processing equipment, machine tools, metal cutting machines, and inspection machines.

The illumination source of illumination system 842 may be g-line (436 nanometers (nm)), i-line (365 nm), a KrF excimer laser (248 nm), a ArF excimer laser (193 nm), and an F.sub.2-type laser (157 nm). Alternatively, illumination system 842 may also use charged particle beams such as x-ray and electron beams. For instance, in the case where an electron beam is used, thermionic emission type lanthanum hexaboride (LaB.sub.6) or tantalum (Ta) may be used as an electron gun. Furthermore, in the case where an electron beam is used, the structure may be such that either a mask is used or a pattern may be directly formed on a substrate without the use of a mask.

With respect to projection optical system 846, when far ultra-violet rays such as an excimer laser is used, glass materials such as quartz and fluorite that transmit far ultraviolet rays is preferably used. When either an F.sub.2-type laser or an x-ray is used, projection optical system 846 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. No. 5,623,853 or U.S. Pat. No. 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

As described above, a photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

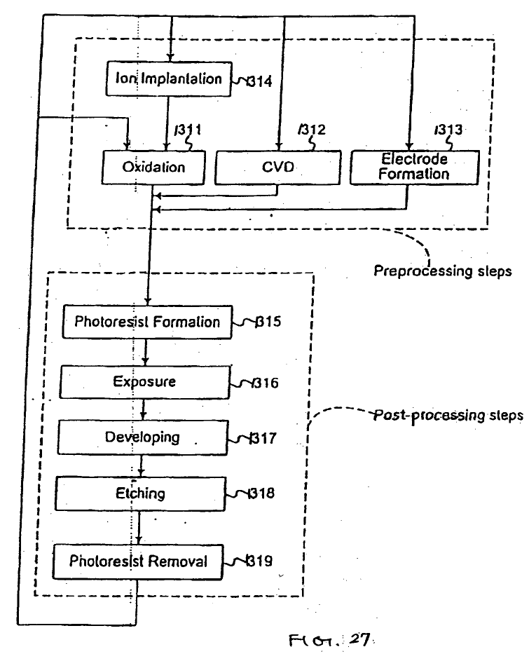

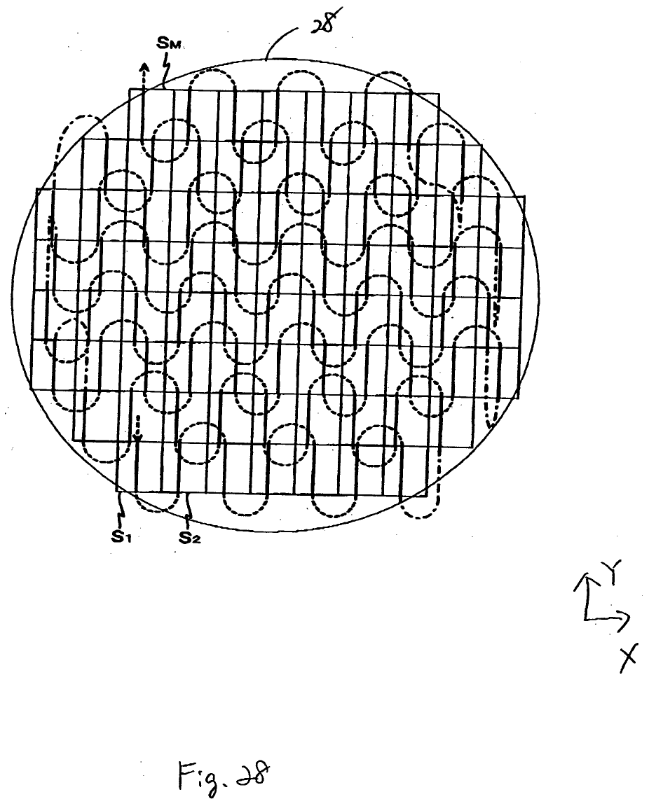

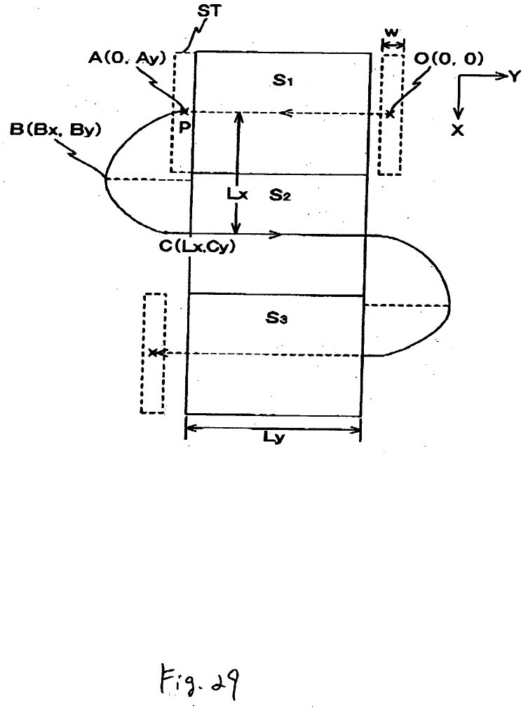

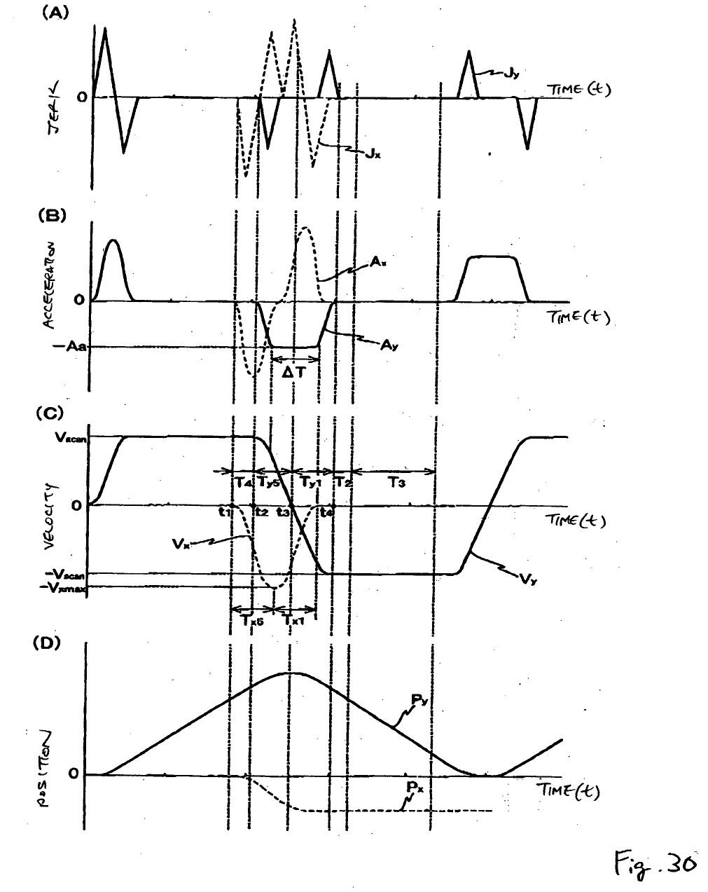

Further, semiconductor devices may be fabricated using systems described above, as will be discussed with reference to FIG. 26. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system that includes a coarse reticle scanning stage and a fine reticle scanning stage that accelerates with the coarse reticle scanning stage as described above. One process of exposing a mask pattern onto a wafer will be described below with respect to FIG. 27. In step 1305, the semiconductor device is assembled. The assembly of the semiconductor device generally includes, but is not limited to, wafer dicing processes, bonding processes, and packaging processes. Finally, the completed device is inspected in step 1306.

FIG. 27 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage. In one embodiment, scanning the reticle scanning stage includes accelerating a fine stage with a coarse stage using a cord, then accelerating the fine stage substantially independently from the coarse stage.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

While cords are suitable for providing an overall reticle scanning stage device with dual force mode capabilities, it should be appreciated that cords are just one example of a “variable coupler,” i.e., a coupler between a coarse stage and a fine stage that may alternately be characterized by allowing high transmissibility between the stages and allowing relatively low transmissibility between the stages. Other suitable couplers include, but are not limited to, opposing motors which are coupled to substantially stationary amplifiers, and stops.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A method of compensating for force ripple of an apparatus driven by a force produced by a linear motor, the method comprising:
generating force commands for a trajectory starting at a plurality of starting positions of the apparatus driven by the linear motor to produce different trajectory motions based on the same trajectory at the plurality of starting positions, the force commands each including peaks of large acceleration/deceleration and valleys of low force levels;
calculating an average of the force commands during large acceleration/deceleration generated based on trajectory motions for the plurality of starting positions;
calculating a variation ratio of the force command for each trajectory motion to the calculated average of the force commands; and
compensating for force ripple in the apparatus based on the calculated variation ratio to control the force applied by the linear motor to the apparatus.

2. The method of claim 1 further comprising performing an iterative learning control process on iterative learning control input data used to control the force applied by the linear motor to the apparatus.

3. The method of claim 2 wherein the iterative learning control input data comprises a following error which is a difference between an intended trajectory for the apparatus and an actual trajectory of the apparatus.

4. The method of claim 3 wherein compensating for force ripple comprises generating a force ripple lookup table based on the calculated variation ratio; and
applying the force ripple lookup table to the following error subsequent to the iterative learning control process to produce a control signal for controlling the force applied by the linear motor to the apparatus.

5. The method of claim 3 further comprising:
generating a feedback control signal based on the following error subsequent to the iterative learning control process;
generating a feedforward control signal based on the intended trajectory; and
combining the feedback control signal and the feedforward control signal to produce an adjusted following error.

6. The method of claim 5 wherein compensating for force ripple comprises generating a force ripple lookup table based on the calculated variation ratio; and applying the force ripple lookup table to the adjusted following error to produce a control signal for controlling the force applied by the linear motor to the apparatus.

7. The method of claim 1 wherein compensating for force ripple comprises generating a force ripple lookup table based on the calculated variation ratio and applying the force ripple lookup table to a control signal for controlling the force applied by the linear motor to the apparatus.

8. A method of operating an exposure apparatus comprising:
transporting a substrate with a stage having a plurality of linear motors;
controlling the plurality of linear motors utilizing the method of claim 1 to move the substrate; and
exposing the substrate with radiant energy.

9. A method of making a micro-device including at least a photolithography process, wherein the photolithography process utilizes the method of operating an exposure apparatus of claim 8.

10. A method for making a wafer utilizing the method of operating an exposure apparatus of claim 8.

11. A system of controlling movement of a stage including at least one linear motor to produce a force to move a substrate for processing, the system comprising:
a position compensation module configured to generate a force ripple compensation for adjusting the force applied by the linear motor to the stage; and
a stage control module configured to use the generated force ripple compensation to control movement of the stage to compensate for force ripple of the linear motor.

12. The system of claim 11 wherein the position compensation module is configured to
generate force commands for a trajectory starting at a plurality of starting positions of the stage driven by the linear motor to produce different trajectory motions based on the same trajectory at the plurality of starting positions, the force commands each including peaks of large acceleration/deceleration and valleys of low force levels;
calculate an average of the force commands during large acceleration/deceleration generated based on trajectory motions for the plurality of starting positions;
calculate a variation ratio of the force command for each trajectory motion to the calculated average of the force commands; and
determine the force ripple compensation based on the calculated variation ratio to control the force applied by the linear motor to the stage.

13. The system of claim 12 wherein the position compensation module is configured to perform an iterative learning control process on iterative learning control input data used to control the force applied by the linear motor to the stage.

14. The system of claim 13 wherein the iterative learning control input data comprises a following error which is a difference between an intended trajectory for the apparatus and an actual trajectory of the stage.

15. The system of claim 14 wherein the position compensation module is configured to generate a force ripple lookup table based on the calculated variation ratio; and
apply the force ripple lookup table to the following error subsequent to the iterative learning control process to produce a control signal for controlling the force applied by the linear motor to the stage.

16. The system of claim 14 wherein the position compensation module is configured to
generate a feedback control signal based on the following error subsequent to the iterative learning control process;
generate a feedforward control signal based on the intended trajectory; and
combine the feedback control signal and the feedforward control signal to produce an adjusted following error.

17. The system of claim 16 wherein the position compensation module is configured to generate a force ripple lookup table based on the calculated variation ratio; and apply the force ripple lookup table to the adjusted following error to produce a control signal for controlling the force applied by the linear motor to the stage.

18. The system of claim 13 wherein the position compensation module is configured to generate a force ripple lookup table based on the calculated variation ratio; and apply the force ripple lookup table to a control signal for controlling the force applied by the linear motor to the stage.

19. A stage device comprising:
a stage that retains an object; and
the system of claim 12,
wherein the system is configured to control the movement of the stage that retains the object.

20. An exposure apparatus comprising:
an illumination system that irradiates radiant energy; and
the stage device according to claim 19, the stage device carrying the object disposed on a path of the radiant energy.

21. A system for controlling movement of a stage including at least one linear motor to produce a force to move a substrate for processing, the system having one or more memories, the one or more memories comprising:
code for generating a force ripple compensation for adjusting the force applied by the linear motor to the stage; and
code for using the generated force ripple compensation to control movement of the stage to compensate for force ripple of the linear motor.

22. The system of claim 21 wherein the code for generating the force ripple compensation comprises:
code for generating force commands for a trajectory starting at a plurality of starting positions of the stage driven by the linear motor to produce different trajectory motions based on the same trajectory at the plurality of starting positions, the force commands each including peaks of large acceleration/deceleration and valleys of low force levels;
code for calculating an average of the force commands during large acceleration/deceleration generated based on trajectory motions for the plurality of starting positions;
code for calculating a variation ratio of the force command for each trajectory motion to the calculated average of the force commands; and
code for determining the force ripple compensation based on the calculated variation ratio to control the force applied by the linear motor to the stage.

23. The system of claim 22 further comprising code for performing an iterative learning control process on iterative learning control input data used to control the force applied by the linear motor to the stage.

24. The system of claim 23 wherein the iterative learning control input data comprises a following error which is a difference between an intended trajectory for the apparatus and an actual trajectory of the stage.

25. The system of claim 24 wherein the code for generating a force ripple compensation comprises code for generating a force ripple lookup table based on the calculated variation ratio; and code for applying the force ripple lookup table to the following error subsequent to the iterative learning control process to produce a control signal for controlling the force applied by the linear motor to the stage.

26. The system of claim 24 further comprising:
code for generating a feedback control signal based on the following error subsequent to the iterative learning control process;
code for generating a feedforward control signal based on the intended trajectory; and
code for combining the feedback control signal and the feedforward control signal to produce an adjusted following error.

27. The system of claim 26 wherein the code for generating the force ripple compensation comprises code for generating a force ripple lookup table based on the calculated variation ratio; and code for applying the force ripple lookup table to the adjusted following error to produce a control signal for controlling the force applied by the linear motor to the stage.

28. The system of claim 21 wherein the code for generating the force ripple comprises code for generating a force ripple lookup table based on the calculated variation ratio; and code for applying the force ripple lookup table to a control signal for controlling the force applied by the linear motor to the stage.
